(19) United States
(12) Patent Application Publication
(10) Pub. No.: US 2025/0211895 A1
(43) Pub. Date: Jun. 26, 2025

(54) GASKET WITH SHARED SOUND PORT

(71) Applicant: Soundskrit Inc., Montreal (CA)

(72) Inventors: Sahil Gupta, Montreal (CA); Stephane Leahy, Montreal (CA)

(21) Appl. No.: 18/991,949

(22) Filed: Dec. 23, 2024

Related U.S. Application Data
(60) Provisional application No. 63/614,127, filed on Dec. 22, 2023.

(51) Int. Cl. H04R 1/32; H04R 1/08

(52) U.S. Cl. CPC H04R 1/326; H04R 1/08

(57) ABSTRACT

A device includes a housing having a sound port, a gasket disposed within the housing, the gasket including an opening aligned with the sound port and a pair of acoustic channels that terminate at the opening to acoustically couple the pair of acoustic channels to the sound port, a directional microphone coupled to the pair of acoustic channels, and a mesh disposed between the housing and the gasket, the mesh extending across the sound port and the opening. The opening and the sound port establish a shared sound port for the directional microphone having an area larger than cross-sectional areas of the pair of acoustic channels.

### CROSS-REFERENCE TO RELATED APPLICATION

This application claims the benefit of U.S. provisional application entitled “Gasket with Shared Sound Port,” filed Dec. 22, 2023, and assigned Ser. No. 63/614,127, the entire disclosure of which is hereby expressly incorporated by reference.

### BACKGROUND OF THE DISCLOSURE

### Field of the Disclosure

The disclosure relates generally to microphones.

### Brief Description of Related Technology

Meshes are often used to support the integration of a microphone into an electronic device. The mesh is often disposed underneath a sound port in a housing of the electronic device to help protect against dust and water ingress. Oftentimes, meshes that provide a greater degree of ingress protection also have a high acoustic resistance, impacting the performance of the microphone by reducing its sensitivity to a given sound wave. Making matters worse, when integrating a directional microphone into an electronic device, two sound ports are typically present in the housing of the electronic device in order to support the operation of the directional microphone.

### SUMMARY OF THE DISCLOSURE

In accordance with one aspect of the disclosure, a device includes a housing having a sound port, a gasket disposed within the housing, the gasket including an opening aligned with the sound port, and a pair of acoustic channels that terminate at the opening to acoustically couple the pair of acoustic channels to the sound port, a directional microphone coupled to the pair of acoustic channels, and a mesh disposed between the housing and the gasket, the mesh extending across the sound port and the opening. The opening and the sound port establish a shared sound port for the directional microphone having an area larger than cross-sectional areas of the pair of acoustic channels.

In connection with any one of the aforementioned aspects, the devices and/or methods described herein may alternatively or additionally include or involve any combination of one or more of the following aspects or features. The opening includes an indentation along a surface of the gasket adjacent to the housing. The pair of acoustic channels terminate at opposing edges of the opening. The mesh is adhesively secured to the housing and the gasket. The mesh is configured to deter dust ingress into the housing. A diameter of the opening is larger than a diameter of each acoustic channel of the pair of acoustic channels. The housing has a thickness at the sound port lower than a thickness of the gasket. The device further includes a printed circuit board that supports the directional microphone. The printed circuit board includes an opening at which one of the pair of acoustic channels terminates. The housing has a thickness at the sound port less than a combined thickness of the printed circuit board and the directional microphone. The sound port of the housing includes a perforated opening. The housing is configured to define an air gap between the perforated opening and the mesh. The pair of acoustic channels are disposed in a V-shaped arrangement. The directional microphone includes a MEMS microphone. The directional microphone includes a lid and a substrate. A first acoustic channel of the pair of acoustic channels is connected to an opening in the lid. A second acoustic channel of the pair of acoustic channels is connected to an opening in the substrate.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a schematic, sectional view of a directional microphone disposed in an electronic device housing having a shared sound port in accordance with one example.

FIG. 2 is a schematic, sectional view of a directional microphone disposed in an electronic device housing having a shared sound port in accordance with another example.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Described herein are microphone devices having a microphone gasket for directional microphones that use a shared sound port (e.g., single shared sound port) in a housing of an electronic device into which the microphone device is integrated. The gasket and shared port arrangement allow stronger meshes to be used for ingress protection, while minimally impacting microphone performance.

For a given mesh with an acoustic resistance, the larger the sound port the mesh is placed on top of, the less effect the mesh has on the microphone. In other words, the larger the free-hanging area of the mesh where the mesh can vibrate in response to a sound wave, the less the mesh reduces the sensitivity of the microphone.

The gasket and shared port arrangement of the disclosed devices is useful in connection with integrating directional microphones into electronic devices. The shared port minimizes or reduces the number of ports in the housing of the electronic device. When integrating microphones inside of electronic devices, it is useful to reduce the number of holes, or sound ports, introduced in the electronic device housing. Without the shared port, the directional microphone would otherwise involve two sound ports in the electronic device housing.

The microphone devices are well-suited for use in connection with a wide variety of microelectromechanical system (MEMS) microphones. In some cases, the MEMS microphone includes a transducer having a plate-shaped moving electrode and/or electrodes with interdigitated fingers. Other transducer configurations may be used. Any type of MEMS directional transducer may be used.

The gasket and shared port arrangement is useful in connection with a wide variety of electronic devices. In some cases, the electronic device may be or include, for instance, a laptop computer, a tablet, a smartphone, or other portable electronic device. The nature, size, form factor, and other characteristics of the electronic device may thus vary. The composition and other characteristics of the housing of the electronic device may also vary.

The configuration, construction, and composition, and other characteristics of the mesh may vary. The disclosed microphone devices are thus not limited to any particular type of mesh material(s).

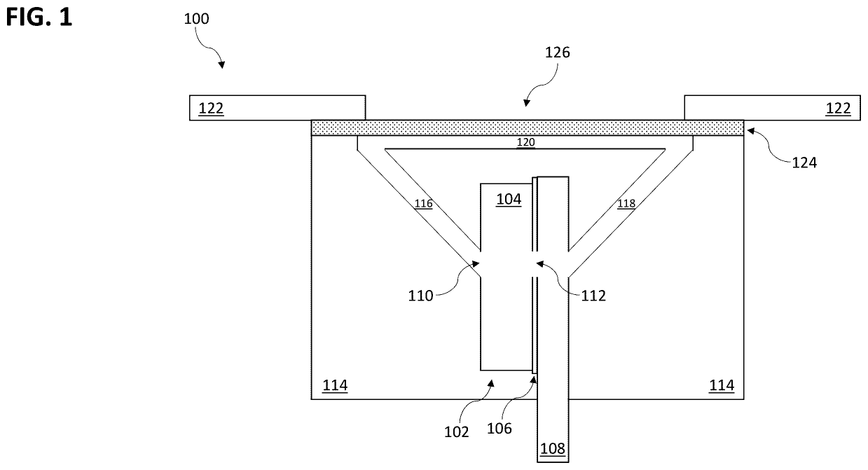

FIG. 1 depicts an electronic device 100 (or “final product”) having a directional microphone 102 and a shared sound port in accordance with one example. The directional microphone 102 may be or include a MEMS directional microphone. The directional microphone 102 includes a lid 104 supported by a printed circuit board (PCB) or other substrate 106. In this example, the directional microphone 102 is further mounted onto a product PCB 108 of the electronic device 100. The product PCB 108 may be or include a flexible printed circuit board or a hard printed circuit board. The directional microphone 102 has a top sound port 110 embedded or otherwise defined in the lid 104, and a bottom sound port 112 embedded or otherwise defined in the PCB 106. In this example, the bottom sound port 112 of the directional microphone 102 is coupled to a sound port 112 embedded or otherwise defined in the product PCB 106.

The directional microphone 102 is positioned inside of or otherwise disposed in a gasket 114. The gasket 114 may be composed of, or otherwise include, any combination of rubber, foam, adhesive, plastic, or other materials commonly used for microphone gaskets. Sealing of the directional microphone 102 to the gasket 114 may be implemented or realized through compression, an adhesive layer, and/or any other techniques, materials, and/or arrangements to ensure a proper acoustic seal.

Within the gasket 114, the top sound port 110 of the directional microphone 102 is coupled to a top acoustic channel 116. The bottom sound port 112 is coupled to a bottom acoustic channel 118. As shown in FIG. 1, the acoustic channels 116, 118 are separate and distinct from one another. The top acoustic channel 116 and bottom acoustic channel 118 terminate at points that are spaced apart from one another as shown in FIG. 1. As a result, the channels 116, 118 may experience different pressures (or pressure levels) when subjected to a sound wave. However, both of the acoustic channels 116, 118 are coupled to a shared sound port 120, or opening, in the gasket 114. As shown in FIG. 1, the sound port 120 is configured as, or otherwise includes, an aperture or indentation along an outer surface of the gasket 114. In the example of FIG. 1, and as shown therein, the acoustic channels 116, 118 terminate at positions along the perimeter of the opening 120, e.g., at opposing ends or edges of the opening of the shared sound port 120.

As shown in FIG. 1, the acoustic channels 116, 118 may be angled to reach the ends or edges of the sound port 120. The acoustic channels 116, 118 may thus be disposed in a V-shaped arrangement as shown. Other orientations or arrangements may be used in other cases.

The gasket 114 is coupled to a housing 122 of the electronic device 100. In some cases, the gasket 114 is coupled to the housing 122 through or with a mesh 124 disposed between the housing 122 and the gasket 114. As shown in FIG. 1, the mesh 124 extends across the sound port 120 or opening in the gasket 114. In some cases, the mesh 124 may be or include an adhesive overlay. The adhesive overlay may be or include an adhesive tape, such as VHB (or very high bond) tape to adhere the mesh to one or both of the housing 122 and the gasket 114. In some cases, the mesh 124 may include a stacked arrangement including a mesh layer disposed between a pair of adhesive portions. The adhesive portion(s) of the overlay 124 may have an opening (e.g., a central opening) to allow sound to reach the microphone 102.

The housing 122 of the electronic device 100 has a single sound port 126 embedded or otherwise defined in the housing 122. The sound port 126 is aligned with the opening in the gasket 114 as shown in FIG. 1. The mesh 124 extends across the sound port 126 and is configured to prevent or otherwise deter particulate and other material (e.g., liquid) ingress into the opening 120. The mesh 124 is configured to nonetheless allow for the passage of acoustic waves into the opening 120 while preventing the particulate ingress. As shown in FIG. 1, the mesh 124 may extend laterally beyond the perimeters of the sound ports 120, 126.

The sound port 126, the opening 120, and thus the mesh 124 are sized to reduce the acoustic resistance of the mesh 124. The size (e.g., area) of the openings defined by the sound ports 120, 126 is greater than the cross-sectional area of either acoustic channel 116, 118. In some cases, the size of the openings is greater than the combined or composite cross-sectional area of the acoustic channels 116, 118. As shown in the example of FIG. 1, the diameter of the opening 120 may be greater than that of the diameter of the acoustic channels 116 and 118. As a result of the size of the openings defined by the sound ports 120, 126, the acoustic mesh 124 is suspended over a larger cavity, or sound port, than if the mesh were to be directly attached to the opening of either acoustic channel 116 or 118 alone. As a result, the mesh 124 does not introduce as much resistance as if the mesh 124 were attached directly to the acoustic channel 116 or 118. The lower resistance, in turn, reduces the impact on the sensitivity of the directional microphone 102. Furthermore, the electronic device 100 is capable of generating a directional microphone signal with the use of only a single acoustic port, the sound port 126.

The pressures (or pressure levels) present in the acoustic channels 116 and 118 arising from an incident acoustic wave are different when the housing 122 in the vicinity of the directional microphone 102 is sufficiently thin. If the thickness of the housing 122 is sufficiently small, then the acoustic channels 116 and 118 sample a sound wave travelling across the sound port 126 at two different points, and thus see two different pressures that excite the directional microphone 102. If the thickness of the housing 122 is too large, then the pressure difference between the acoustic channels 116 and 118 may be reduced, thus reducing the sensitivity of the directional microphone 102. In some examples, the thickness of the housing 122 may be less than 2 mm. The thickness may vary in other cases. For instance, the thickness of the housing 122 may be less than the thickness of the gasket 114. Alternatively or additionally, the thickness of the housing 122 may be on the order of (i.e., have the same order of magnitude as), or less than, the combined thickness of the microphone 102 and the PCB 108. The thickness of the housing 122 may also vary in accordance with the size or area of the sound port 126, which is determinative of the spacing between the positions at which the acoustic channels 116, 118 terminate. Thus, in some cases, the thickness of the housing 122 may be on the order of, or less than, half of the spacing between the acoustic channels 116, 118.

In order to establish a shared port (e.g., the shared ports 120 and 126) for the acoustic channels 116 and 118, the sound port 126 in the electronic device 100 is relatively large (e.g., a 12 mm diameter) compared to the sound port of a typical microphone. However, a relatively large hole in the electronic device 100 is not always desirable as the hole may be considered to compromise the aesthetics of the final product. In some cases, the use of micro-perforations, or an array of many small holes, may be used instead of a single large hole.

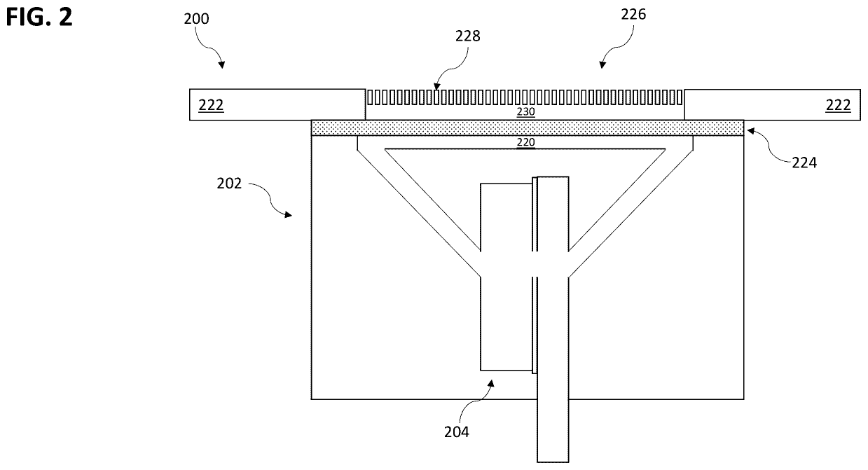

FIG. 2 depicts a cross-section of an electronic device 200 (or final product) with a directional microphone 202 using a shared sound port with micro-perforations in accordance with one example. The electronic device 200 includes a gasket 202, which may be configured similarly to that described in the example of FIG. 1. Within the gasket 202, a directional microphone 204 is coupled to a shared sound port 220 (or opening). The gasket 202 is coupled to a housing 222 of the electronic device 200 through an adhesive stack and/or mesh 224. The housing 222 has a shared sound port 226 that includes perforations 228 (e.g., micro-perforations). Within the sound port 226, there is an air gap 230, or cavity, below the micro-perforations 228. As shown in FIG. 2, the air gap 230 is disposed between the perforated portion of the housing 222 and the shared sound port 220. The air gap 230 ensures that the mesh 224 stays suspended across the entire air gap 230. If the mesh 224 were instead in contact with the perforated portions of the housing 222, then the mesh would effectively be suspended over a smaller open area and introduce a significant resistance to incoming sound, and thus a reduction in microphone sensitivity. In contrast, in the example shown in FIG. 2, the air gap 230 allows the mesh 224 to extend across a sound port (i.e., the sound ports 220, 226) having a significantly larger diameter than the sound ports in the lid and substrate of the microphone 202.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A device comprising:
a housing having a sound port;
a gasket disposed within the housing, the gasket comprising:
an opening aligned with the sound port; and
a pair of acoustic channels that terminate at the opening to acoustically couple the pair of acoustic channels to the sound port;
a directional microphone coupled to the pair of acoustic channels; and
a mesh disposed between the housing and the gasket, the mesh extending across the sound port and the opening;
wherein the opening and the sound port establish a shared sound port for the directional microphone having an area larger than cross-sectional areas of the pair of acoustic channels.

2. The device of claim 1, wherein the opening comprises an indentation along a surface of the gasket adjacent to the housing.

3. The device of claim 1, wherein the pair of acoustic channels terminate at opposing edges of the opening.

4. The device of claim 1, wherein the mesh is adhesively secured to the housing and the gasket.

5. The device of claim 1, wherein the mesh is configured to deter dust ingress into the housing.

6. The device of claim 1, wherein a diameter of the opening is larger than a diameter of each acoustic channel of the pair of acoustic channels.

7. The device of claim 1, wherein the housing has a thickness at the sound port lower than a thickness of the gasket.

8. The device of claim 1, further comprising a printed circuit board that supports the directional microphone, wherein:
the printed circuit board comprises an opening at which one of the pair of acoustic channels terminates; and
the housing has a thickness at the sound port less than a combined thickness of the printed circuit board and the directional microphone.

9. The device of claim 1, wherein the sound port of the housing comprises a perforated opening.

10. The device of claim 9, wherein the housing is configured to define an air gap between the perforated opening and the mesh.

11. The device of claim 1, wherein the pair of acoustic channels are disposed in a V-shaped arrangement.

12. The device of claim 1, wherein:
the directional microphone comprises a MEMS microphone;
the directional microphone comprises a lid and a substrate;
a first acoustic channel of the pair of acoustic channels is connected to an opening in the lid; and
a second acoustic channel of the pair of acoustic channels is connected to an opening in the substrate.
